(19) United States
(12) Patent Application Publication
(10) Pub. No.: US 2004/0096751 A1
(43) Pub. Date: May 20, 2004

(54) METHOD FOR THE MANUFACTURE OF HIGH-QUALITY TOTAL INTERNAL REFLECTION HOLOGRAMS

(76) Inventor: FRANCIS S. M. CLUBE, NEUCHATEL (CH)

Correspondence Address: LEO STRANGER, BOX 1455, 382 SPRINGFIELD AVE, SUMMIT, NJ, 07901

(21) Appl. No.: 08/336,567

(22) Filed: Nov. 9, 1994

Related U.S. Application Data
(63) Continuation of application No. 08/018,183, filed on Feb. 16, 1993, now abandoned.

(30) Foreign Application Priority Data
Feb. 13, 1992 (GB) 9205560.7

(51) Int. Cl. G03H 1/04; G03H 1/20

(52) U.S. Cl. 430/1; 430/2; 359/15; 359/12; 430/5

(57) ABSTRACT

In the manufacture of an array total internal reflection hologram for printing a pattern of high-quality microfeatures over a large area, a mask defining just a part of the pattern is used to record an array of sub-holograms, the holographic recording medium or the mask being moved with respect to each other subsequent to the recordal of each sub-hologram, thereby building up a hologram of the complete pattern to be printed.

### FIELD OF THE INVENTION

The present invention relates generally to the field of microlithography as employed for the manufacture of electronic and other types of device comprising high-resolution features. It takes advantage of the particular imaging properties of total internal reflection holography to achieve a novel method and apparatus for attaining greater lithographic accuracy and therefore superior device performance.

### BACKGROUND ART

Most high-resolution (<1.5 μm) lithographic processes for fabricating microdevices start with a mask, or a set of masks, defining the pattern of features that need to be formed on a substrate surface, for instance, on a silicon wafer. The pattern is transferred to the substrate either by contact printing the mask or by imaging the mask through a lens and/or mirror system. The latter is often preferable, especially for large production quantities, because it avoids damage to the mask. The main shortcoming of high-resolution imaging systems (apart from their cost) is that off-axis optical aberrations limit the size of the exposure field to typically 1.5×1.5 cm², and in order to print onto a larger area, such as an 8″ diameter silicon wafer, a multi-exposure step-and-repeat procedure is employed, in which each exposure prints a single device, or maybe a small number of devices, and the wafer is translated between exposures. Not only is this size of exposure field restrictive for many types of device (eg. for CCDs and DRAMs) but the stepping motion requires very sophisticated mechanics in order to achieve good layer-to-layer registration and high throughput.

Device performance is dependent on how accurately the smallest device features (critical dimensions or CDs) can be realised and located with respect to other features. For this reason the pattern in the mask is best fabricated using electron beam (e-beam) lithography. However, although very precise, e-beam lithography also has its limitations. An approach that is therefore commonly used to ensure high accuracy of printed features is to fabricate the mask at a scale five times larger than the pattern required and then, during pattern transfer, to image the mask through 5× reduction optics. By this way any CD or placement errors present in the mask are demagnified to acceptable levels. The problem with this approach is that the reduction optics introduce their own aberrational errors: lens distortion, astigmatism and coma, and these degrade the feature placement accuracy and the CD control.

Total internal reflection (TIR) holography has been demonstrated to be powerful technique for sub-micron lithography 1-3. The main principles of TIR hologram recording are illustrated in FIG. 1. A holographic plate 1 comprising a holographic recording layer 2 on a substrate 3 is in optical contact with a surface of a large prism 4. An object in the form of a mask transparency 5 lies in proximity to the recording layer 2. Two mutually coherent beams illuminate the system. One, the object beam 6, passes through the mask transparency 5 to the recording layer 2 and the other, the reference beam 7, is directed through another face of the prism 4 so that it is totally reflected from the surface of the holographic layer 2. The optical interference of the two beams 6 and 7 is recorded by the photosensitive material in the layer 2 to produce a TIR hologram. The hologram is reconstructed by irradiating it with a laser beam directed in the opposite direction to the reference beam 7. This generates an accurate reproduction of the pattern contained in the original mask 5, and this can be used to perform lithography. TIR holographic imaging, unlike imaging through lens or mirror systems, is free of off-axis aberrations and so allows near diffraction-limited resolution which is furthermore independent of field size. It is therefore able from a single reconstruction to print high-resolution features over very large exposure fields.

However, TIR holography does not permit demagnification of the mask pattern: it is intrinsically a 1× process. Therefore any errors contained in the e-beam mask will necessarily be recorded in the TIR hologram and exactly transferred into the device. With respect to the origins of e-beam mask errors, the placement errors are caused predominantly by mechanical instabilities in the e-beam lithographic system, which are less controllable the longer the write time; whilst the CD errors are introduced predominantly by the spin processing applied to the mask substrate, and these errors vary slowly over the mask area. Therefore, by limiting the mask pattern to a small area (eg. −2×2 cm²) mask errors can be kept to a low level. A small mask pattern has the additional significant advantages of appreciably reducing the mask cost, particulary if the features are very small (eg. <0.5 μm), and also allows redundancy to be used to eliminate mask defects, that is, by writing a number of patterns onto the mask, one can be assured of at least one pattern that will be defect-free. Unfortunately employing such a mask in the TIR hologram recording method as described in the prior art severely compromises the unlimited field capability of TIR holograms. Such a small hologram could be used in a step-and-repeat printing system but such a strategy, as explained above, is not usually desirable.

It is therefore an object of the present invention to provide a method of manufacturing TIR holograms that permits high-resolution, high-accuracy and defect-free patterns to be full-field printed (ie. in a single exposure, without recourse to stepping) over large-area substrates. The invention is an apparatus for and a technique of constructing a plurality of high-quality sub-holograms over a large substrate. The array TIR hologram thus formed can be used to full-field print devices onto large substrates.

### SUMMARY OF THE INVENTION

According to the present invention there is provided a method for manufacturing an array TIR hologram for printing a pattern of high-quality microfeatures over a large area which includes:

a) providing a substrate the size of the pattern to be printed said substrate bearing a holographic recording medium;

b) providing a mask defining a part of the pattern to be printed;

c) recording in the holographic recording medium a TIR sub-hologram of the part of the pattern defined by the mask; and

d) moving said holographic recording medium or said mask with respect to each other in a direction substantially parallel to the holographic recording medium, so as to present a new part of the holographic recording medium for recordal of another TIR sub-hologram of the or another mask.

Said large area preferably corresponds to the complete area to be printed, although it may also refer to a substantial part of that area (eg. half) in which case, during printing, a small number of step-and-repeat operations (eg. two) are required to print the complete area.

Preferred embodiments of the various aspects of the present invention will now be described in detail with reference to the accompanying drawings.

### BRIEF DESCRIPTION OF THE DRAWINGS

FIG. 1, already described, shows the main principles of total internal reflection holography.

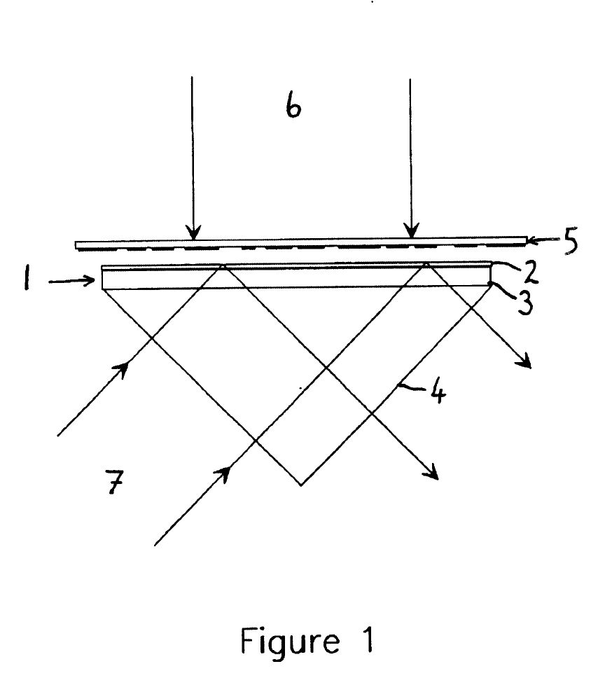

FIG. 2 shows schematically a system for manufacturing high-quality total internal reflection holograms for large-field printing, in accordance with the invention.

### DETAILED DESCRIPTION OF THE PREFERRED EMBODIMENTS

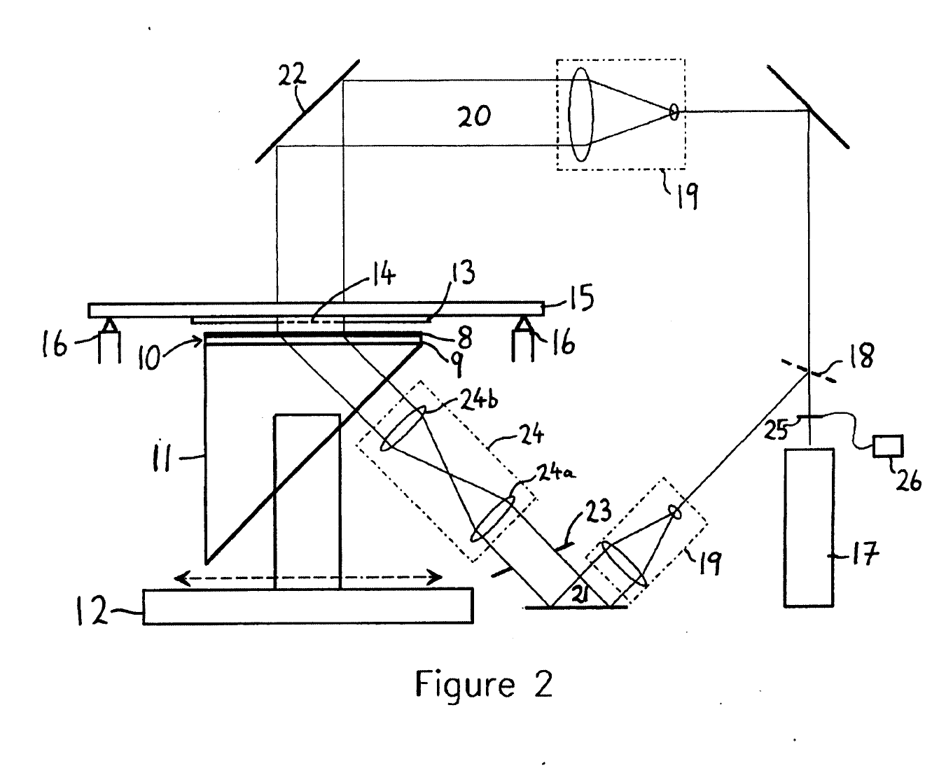

With reference to FIG. 2, a holographic recording layer 8, approximately 15 micron thick, is laminated, or spun, onto a large 5″ diameter glass substrate 9. A holographic recording medium that is particularly good for precision imaging is manufactured by Du Pont de Nemours & Co and identified as HRF-352. This material is a monomer that polymerises on exposure to light, the hologram being recorded as a spatial modulation of refractive index. Since it is desirable to use short wavelengths, specifically ultraviolet (UV), for micro-imaging, the supporting substrate 9 should be transparent to the UV. Fused silica is an optically desirable material and readily available.

The holographic plate 10, comprising the holographic recording layer 8 and the substrate 9, is placed in optical contact with a prism 11 by way of a layer of index matching fluid therebetween. A suitable fluid is the hydrocarbon xylene. The holographic plate 10 and the prism 11 remain in intimate contact throughout the recording process: whenever the prism 11 is moved, the holographic 10 plate moves with it.

The prism 11 is mounted to a high accuracy translation stage 12. The stage 12 is able to travel in two orthogonal directions, permitting motion of the holographic layer 8 in the plane of the layer. For the manufacture of micro devices comprising many layers of features and consequently requiring accurate registration between layers, it is further preferable that the stage 12 be equiped with laser interferometers so that the holographic layer 8 can be translated with high precision.

An e-beam written mask 13 defining a pattern of features 14 of resolution 0.5 μm in a pattern area 2 cm×2 cm is procured. The placement accuracy of features in the pattern 14 is ±0.05 μm and the spread of CD errors is ±0.03 μm. The area on the mask 13 surrounding the pattern 14 is opaque, for reasons explained later.

The mask 13 is mounted to a vacuum chuck 15 and the chuck 15 is placed on piezoelectric transducers 16 so that the mask 13 lies in close proximity to the recording layer 8.

The mask 13 is then accurately positioned using the piezo-electric transducers 16 so that it lies parallel and at a distance of 100 μm from the recording layer 8.

The measurement of the separation of the mask 13 and holographic layer 8 and determination of their parallelism are preferably carried out interferometrically using laser beams introduced through the vertical face of the prism (for instance using the technique described in EP A 02421645). The apparatus for doing this is not shown in the figure as it could be easily formulated by a skilled person.

An argon ion laser 17 operating at a wavelength of 364 nm, a beam splitter 18 and beam expanding optics 19 are used to generate two mutually coherent, collimated and large diameter beams: an object beam 20 and a reference beam 21. The object beam 20 is directed by a mirror 22 to the mask 13 such that it illuminates it at normal incidence, and the reference beam 21 passes through the hypotenuse face of the prism 11 and illuminates the recording layer 8 at such an angle that it is totally internally reflected from the layer surface.

Before arriving at the prism 11 the reference beam 21 passes through an aperture 23 and an optical relay 24, comprising two lenses 24a and 24b. The function of the optical relay is to image the illuminated aperture 23 onto the recording layer 8. The aperture 23 is positioned at the front focal plane of lens 24a, and the second lens 24b is placed such that its front focal plane is co-planar with the back focal plane of the lens 23a. The back focal plane of lens 24b is at the recording layer 8. In order that the image of the aperture 23 lies in the plane of the recording layer, the aperture 23 is appropriately oriented at the front focal plane of lens 24a.

The purpose of the aperture 23 and optical relay 24 is to ensure that only that part of the holographic layer 8 immediately below the pattern 14 in the mask 13 is illuminated by the reference beam 21 and furthermore to ensure that this beam 21 is uniformly bright and well-collimated across its extent. The opaque area surrounding the pattern 14 in the mask 13 shields the rest of the holographic layer 8 from the object beam 20. By these means the separation of sub-holograms can be minimised while ensuring good uniformity of image brightness and no interference between sub-holograms.

Exposure of the recording layer 8 to the illuminating object and reference beams 20 and 21 results in a sub-hologram of the pattern 14 in the mask 13 being recorded in that part of the layer 8 directly below the pattern in the mask 13. After sufficient exposure with regard to the sensitivity of the material, the bean from the laser 17 is interrupted by a mechanical shutter 25 controlled by a timing mechanism 26.

The prism 11 and holographic plate 10 are then translated laterally using the translation stage 12 by a distance such that the exposed part of the recording layer 8 is moved away from the region of intersection of the two beams 20 and 21 and an unexposed region of the layer 8 is moved in. As mentioned earlier, for multi-level devices this movement must be carried out with precision in order that accurate overlay can be achieved during lithography.

Following this, it may be necessary to readjust the piezo-electric transducers 16 supporting the mask 13 in order that the mask 13 remains parallel to the recording layer 8 and at the same distance from the layer 8.

In the case where the direction of translation of the recording layer 8 lies in the plane of incidence of the reference beam 21 at the layer 8, the aperture 23 should ideally be shifted longitudinally, that is, along the optical axis of the relay lens system 24, in order that the image of the aperture remains accurately focussed onto the recording layer 8.

The translation of the recording layer 8 with respect to the mask 13 may alternatively be achieved by a displacement of the mask 13. However, in this case, the object and reference beams 20 and 21 must preferably be displaced as well in order to ensure good reproducibility of exposure energy from exposure to exposure. The mechanical arrangement required for implementing this, which is not shown in FIG. 2, is more elaborate, making this approach less desirable.

The mechanical shutter 25 is activated again and the fresh part of the holographic layer 8 now under the pattern in the mask is exposed for the same length of time to the object and reference beams 20 and 21, to form another sub-hologram.

In case the output of the laser is not sufficiently stable to ensure equality of exposure for each sub-hologram so as to obtain equal sub-hologram efficiencies, the mechanical shutter 25 may alternatively be controlled from a light integrator that measures the total exposure energy.

These step-and-expose operations are subsequently repeated many times to construct an array of sub-holograms whose total area corresponds to that of the substrate to be printed.

The holographic plate 10 is then removed from the prism 11 and the holographic layer 8 is fixed by exposing it to an incoherent light source such as a mercury lamp. An alternative fixing procedure is to include this operation as part of the repeat sequence, that is, to fix each sub-hologram immediately following holographic exposure and before translating the prism assembly for exposure of the next sub-hologram. This would best be done in situ by way of another optical sub-system.

The resulting array TIR hologram can then be inserted into a TIR holographic lithographic system in order that the high-quality images from all the sub-holograms can be printed in one exposure onto a large substrate.

### REFERENCES

1. R. Dändliker, J. Brook, “Holographic Photolithography for Submicron VLSI Structures”, IEEE Conf. Proc. Holographic Systems, Components and Applications, Bath, U.K., p. 311 (1989).

2. S. Gray, M. Hamidi, “Holographic Microlithography for Flat Panel Displays”, SID 91 Digest pp. 854-857 (1991).

3. B. A. Omar, F. Clube, N. Hamidi, D. Struchen, S. Gray, “Advances in Holographic Lithography”, Solid State Technology, pp. 89-93, September 1991.

1. A method for manufacturing an array total internal reflection hologram for printing a pattern of high-quality microfeatures over a large area, which method includes:
a) providing a substrate the size of the complete pattern to be printed said substrate bearing a holographic recording medium;
b) providing a mask defining a part of the pattern to be printed;
c) recording in the holographic recording medium a TIR sub-hologram of the part of the pattern defined by the mask; and
d) moving said holographic recording medium or said mask with respect to each other in direction substantially parallel to be holographic recording medium, so as to present a new part of the holographic recording medium for recordal therein of another TIR sub-hologram of the or another mask.

2. A method according to claim 1, further comprising the step of repeating steps (c) and (d) as many times as necessary so as to record in the holographic recording medium an array of TIR sub-holograms recording the pattern to be printed.

3. A method according to claim 2, wherein in step (d) said movement is effected in one or more of two orthogonal directions.

4. A method according to claim 2, wherein the mask is held substantially parallel to the halographic recording medium and at a fixed distance therefrom.

5. A method according to claim 2, further comprising the step of fixing each sub-hologram immediately after its recordal in the holographic recording medium.

6. A method according to claim 2, further comprising the step of fixing the array of TIR sub-holograms subsequent to their recordal in the holographic recording medium.
